(19) United States
(12) Patent Application Publication
(10) Pub. No.: US 2013/0337164 A1
(43) Pub. Date: Dec. 19, 2013

(54) ADHESIVE DISPENSER AND ADHESIVE NOZZLE REGULATING METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: TENG-TSUNG HUANG, New Taipei (TW); GUO-JUN YU, Shenzhen (CN); GONG-SHUI CHENG, Shenzhen (CN)

(21) Appl. No.: 13/912,614

(22) Filed: Jun. 7, 2013

(30) Foreign Application Priority Data
Jun. 15, 2012 (CN) 2012101978934

(51) Int. Cl. B05C 21/00

(52) U.S. Cl. CPC B05C 21/00
USPC 427/207.1; 118/712

(57) ABSTRACT

An adhesive dispenser includes a moving assembly, a detecting assembly, and an adhesive dispensing assembly. The detecting assembly includes two pairs of light elements, which transmits light beams from a first element of each pair to the second element of each pair. The adhesive dispensing assembly includes a control unit, a drive unit, and an adhesive nozzle, the control unit is for driving the adhesive nozzle to move. The control unit drives the adhesive nozzle to block the light beams of the two pairs of light elements and records the coordinate position of the adhesive nozzle when blocking both the light beams, and calculates a variety of the recorded coordinate position and a reference coordinate position, then controls the drive unit to regulate the position of the adhesive nozzle according to the variety. An adhesive nozzle regulating method is also described.

### BACKGROUND

1. Technical Field

The present disclosure relates to an adhesive dispenser, especially to an adhesive dispenser automatically regulating adhesive nozzle and an adhesive nozzle regulating method.

2. Description of Related Art

Adhesive nozzles of adhesive dispensers are needed to be manually changed after extended use. However, after the nozzle is manually changed, the position of the adhesive nozzle related to an adhesive cylinder will be different from its previous position. Thus, errors may occur because the adhering path is changed accordingly. Therefore, the quality of the product may be affected.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views.

FIG. 1 is an isometric view of an exemplary embodiment of an adhesive dispenser.

FIG. 2 is an isometric view of a moving assembly of the adhesive dispenser shown in FIG. 1.

FIG. 3 is an isometric view of a detecting assembly of the adhesive dispenser shown in FIG. 1.

FIG. 4 is an isometric view of an adhesive dispensing assembly shown in FIG. 1.

FIG. 5 is an isometric view of an adhesive nozzle placed in the detecting assembly shown in FIG. 1.

### DETAILED DESCRIPTION

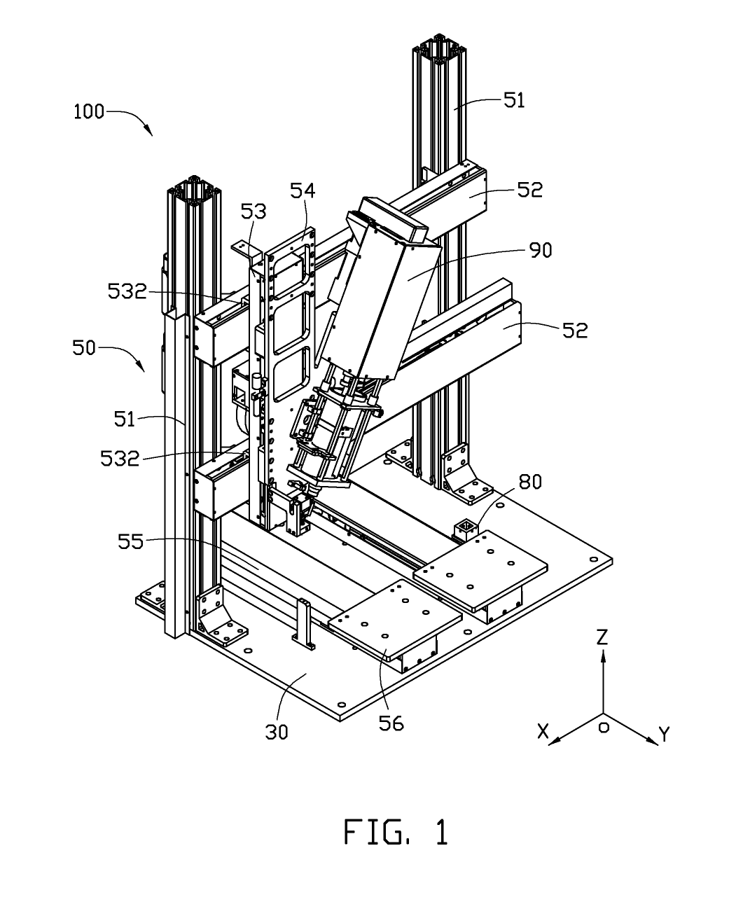

Referring to FIG. 1, an adhesive dispenser 100 according to an exemplary embodiment is for dispensing adhesive onto products (not shown), such as the housings of electronic devices. The adhesive dispenser 100 includes a base 30, a moving assembly 50, a detecting assembly 80, and an adhesive dispensing assembly 90.

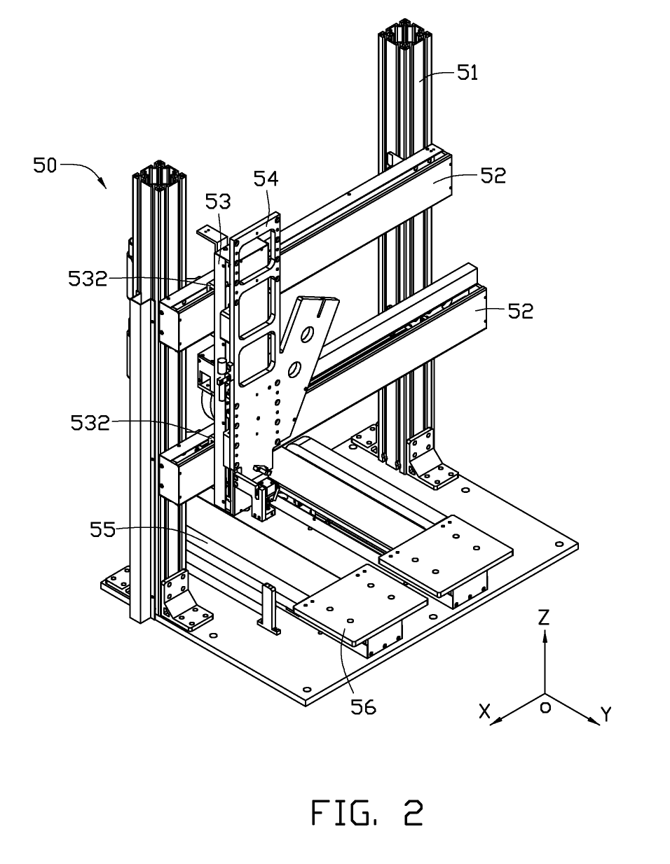

FIG. 2 shows an X-Y-Z coordinate system. The moving assembly 50 is mounted on the base 30 for moving the adhesive dispensing assembly 90 along the X-axis, the Y-axis, and the Z-axis. The moving assembly 50 includes two posts 51, two fastening plates 52, a connecting plate 53, a slide plate 54, two guiding plates 55, and two seats 56. The two posts 51 are perpendicularly supported on the base 30, along the Z-axis. The two fastening plate 52 are arranged in parallel to each other on the two posts 51, along the X-axis. The connecting plate 53 is slidably mounted along the X-axis on the two fastening plates 52. Two first slide blocks 532 are formed on the connecting plate 53. Each first slide block 532 is slidably engaged with one fastening plate 52, thus the connecting plate 53 slidable relative to the fastening plates 52 along the X-axis. The connecting plate 53 may be driven to move along the fastening plates 52 by a motor (not shown).

The slide plate 54 is slidably engaged with the connecting plate 53 along the Z-axis. The adhesive dispensing assembly 90 is fastened to the slide plate 54, thus, the distances along the X-direction and the Z-direction of the adhesive dispensing assembly 90 can be adjusted by moving the slide plate 54, and the connecting plate 53, and the position of the adhesive dispensing assembly 90 at the X-axis and the Z-axis will be adjusted.

The two guiding plates 55 are arranged in parallel on the base 30 along the Y-axis. The seats 56 are configured for supporting products (not shown). Each seat 56 is slidably mounted on one corresponding guiding plate 55. To move the seats 56 along the guiding plates 55, the Y-direction distance of the adhesive dispensing assembly 90 will be jointly changed, and the position of the adhesive dispensing assembly 90 at the Y-axis is adjusted. As such, to adapt to a variety of dispensing requirements, the position of the adhesive dispensing assembly 90 can be easily adjusted by moving the connecting plate 53, the slide plate 54, and the seats 56. Furthermore, the adhesive dispenser 100 includes two guiding plates 55 and two seats 56, the objects to receive adhesive can be alternately positioned on the two seats 56, which effectively improves the dispensing efficiency of the adhesive dispenser 100.

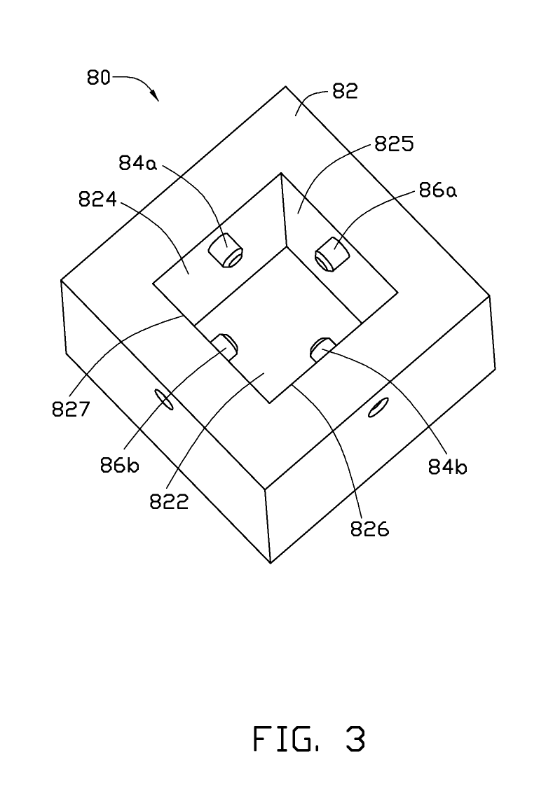

Referring to FIGS. 2 and 3, the detecting assembly 80 is mounted on one of the seat 56 and is for detecting a position of the adhesive dispensing assembly 90. The detecting assembly 80 includes a pedestal 82, a first pair of light elements 84a, 84b, and a second pair of light elements 86a, 86b. The pedestal 82 defines a receiving groove 822, the receiving groove 822 is surrounded by a sidewall 824, a second sidewall 825, a third sidewall 826, and a fourth sidewall 827 orderly. The first pair of light elements includes a transmitter 84a and a receiver 84b, which are arranged oppositely on the first sidewall 824 and the third sidewall 826, and aimed at each other. The second pair of light elements also includes a transmitter 86a and a receiver 86b, which are arranged oppositely on the second sidewall 825 and the fourth sidewall 827, and aimed at each other. The two receivers 84b, 86b respectively receive lights beams transmitted from the corresponding transmitters 84a, 86a, when there's no object blocks the light paths therebetween, and then respectively trigger and transmit a control signal.

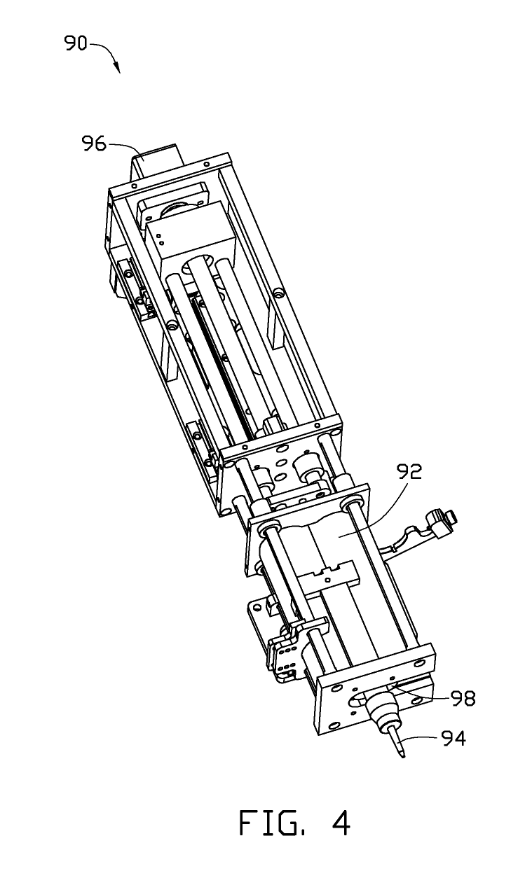

Referring to FIG. 4, the adhesive dispensing assembly 90 includes an adhesive cylinder 92, an adhesive nozzle 94, a control unit 96, and a drive unit 98. The adhesive cylinder 92 contains flowable glue therein. The adhesive nozzle 94 is arranged on an end of the adhesive cylinder 92 to dispense the glue onto a component. The adhesive nozzle 94 moves with respect to the receiving groove 822, and the position of the adhesive nozzle 94 at the X-axis, the Y-axis, and the Z-axis will be adjusted by the driven of the moving assembly 50 until the adhesive nozzle 94 blocks the light beams of the two pairs of light elements 84a, 84b, 86a, 86b. The control unit 96 is arranged on the other end of the adhesive cylinder 92 and controls the quantity of the glue dispensed from the adhesive nozzle 94. The drive unit 98 is mounted on the adhesive nozzle 94 and drives the adhesive nozzle 94.

The control unit 96 is electrically connected to the two pairs of light elements 84a, 84b, 86a, 86b and receives the control signal transmitted from the two pairs of light elements 84a, 84b, 86a, 86b when the light beams therebetween is blocked, and the control unit 96 records the coordinate position.

The control unit 96 is electrically connected to the drive unit 98 to controls the drive unit 98 to adjust the position of the adhesive nozzle 94. Particularly, the control unit 96 stores an reference coordinate position of the adhesive nozzle 94 and calculates the variation of the recorded coordinate position related to the reference coordinate position. In the present embodiment, the reference coordinate position of the adhesive nozzle 94 can be the position before the last adhesive nozzle 94 being changed. The control unit 96 controls the drive unit 98 to adjust the adhesive nozzle 94 according to the variation, thus to regulate the position of the adhesive nozzle 94 related to the adhesive cylinder 92.

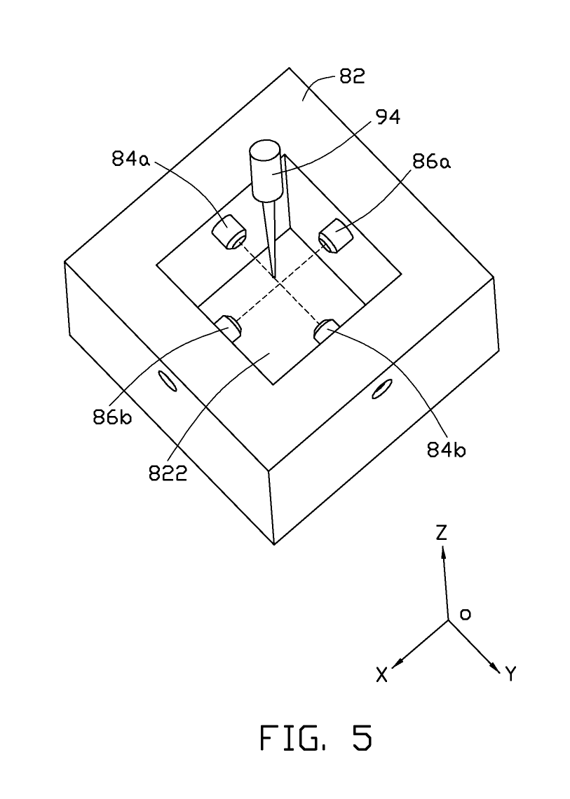

Referring to FIGS. 5, an adhesive nozzle regulating method is described as below. When the adhesive nozzle 94 is needed to be changed, a new adhesive nozzle 94 is mounted on the adhesive cylinder 92. The moving assembly 50 drives the adhesive dispensing assembly 90 to move the adhesive nozzle 94 into the receiving groove 822. The moving assembly 50 drives the adhesive nozzle 94 to move along the X-direction and the Z-direction until an extreme point of the adhesive nozzle 94 blocks the light beam between the first pair of light elements 84a, 84b on the X-direction and the Z-direction. After crossing the extreme point, the adhesive nozzle 94 can not block the light beam between the first pair of light elements 84a, 84b on the X-direction and the Z-direction. Lastly, the moving assembly 50 drives the adhesive nozzle 94 to move along the Y-direction until the adhesive nozzle 94 block the light beam between the second pair of light elements 86a, 86b, then the second pair of light elements 86a, 86b triggers the control signal at this time. When the control unit 96 receives the control signal transmitted from the two pairs of light elements 84a, 84b, 86a, 86b and records the coordinate position of the adhesive nozzle 94, and calculates the variation of the recorded coordinate position and the reference coordinate position, then controls the drive unit 98 to adjust the position of the adhesive nozzle 94 according to the variation, thus to regulates the position of the adhesive nozzle 94 related to the adhesive cylinder 92.

A method of confirming the extreme point includes the following steps. The first step, the moving assembly 50 drives the adhesive nozzle 94 along the X-direction (towards the fourth sidewall 827, for example) until the adhesive nozzle 94 blocks the light beam of the first pair of light elements 84a, 84b, then the first pair of light elements 84a, 84b triggers the control signal. The second step, the moving assembly 50 drives the adhesive nozzle 94 along the Z-direction (upwards) until the adhesive nozzle 94 depart the light beam on the X-direction (on a left side of the light beam that near the fourth sidewall 827, for example). The third step, the moving assembly 50 drives the adhesive nozzle 94 along the opposite X-direction (towards the second sidewall 825, for example) the adhesive nozzle 94 blocks the light beam of the first pair of light elements 84a, 84b, then the first pair of light elements 84a, 84b triggers the control signal. The fourth step, the moving assembly 50 drives the adhesive nozzle 94 along the Z-direction (upwards) until the adhesive nozzle 94 depart the light beam on the X-direction (on the right side of the light beam near the second sidewall 825, for example). Repeating the steps until the position of the adhesive nozzle 94 can just both block the light beam of the first pair of light elements 84a, 84b, even further movement from the position, the adhesive nozzle 94 can not block the light beam of the first pair of light elements 84a, 84b, therefore, the position is the extreme point.

The adhesive dispenser 100 of the exemplary embodiment can detects the adhesive nozzle 94 through the two pairs of light elements 84a, 84b, 86a, 86b, and when the adhesive nozzle 94 blocks the light beams of the pair of light elements 84a, 84b, 86a, 86b, the control unit 96 records the position of the adhesive nozzle 94 and compares with the reference position, then regulates the position of the adhesive nozzle 94. The adhesive dispenser 100 regulates accurately the position of the adhesive nozzle 94 after changing a new adhesive nozzle 94, thus avoiding any error on the adhesive dispensing path of the adhesive dispenser 100.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. An adhesive dispenser, comprising:
a moving assembly;
a detecting assembly comprising a pedestal, a first pair of light elements and a second pair of light elements mounted on the pedestal, the two pairs of light elements transmitting light beams from a first element of each pair of the second element of each pair;
an adhesive dispensing assembly comprising a control unit, a drive unit, and an adhesive nozzle, the control unit electrically connected to the drive unit to drive the adhesive nozzle to move, and the adhesive nozzle dispensing adhesives;
wherein the control unit drives the adhesive nozzle to block the light beams of the two pairs of light elements and records the coordinate position of the adhesive nozzle when blocking both the light beams transmitted from the two pairs of light elements, and calculates a variety of the recorded coordinate position and a reference coordinate position, then controls the drive unit to regulate the position of the adhesive nozzle according to the variety.

2. The adhesive dispenser as claimed in claim 1, wherein the pedestal defines a receiving groove, the receiving groove is surrounded by a first sidewall, a second sidewall, a third sidewall, and a fourth sidewall orderly, the first pair of light elements are mounted oppositely on the first sidewall and the third sidewall, the second pair of light elements are mounted oppositely on the second sidewall and the fourth sidewall.

3. The adhesive dispenser as claimed in claim 1, wherein the first pair of light elements and the second pair of light elements trigger a control signal when the light beams thereof are blocked, the control unit is electrically connected to the two pairs of light elements and records the coordinate position of the adhesive nozzle when receiving the control signal.

4. The adhesive dispenser as claimed in claim 1, wherein the adhesive dispensing assembly further includes an adhesive cylinder, the adhesive nozzle and the control unit are mounted on opposite ends of the adhesive cylinder, the control unit controls a quantity of adhesive dispensing of the adhesive cylinder.

5. The adhesive dispenser as claimed in claim 1, further comprising a base, wherein the moving assembly includes two posts, two fastening plates, a connecting plate, and a slide plate, the two posts are perpendicularly supported on the base, the two fastening plate are arranged in parallel to each other on the two posts, the connecting plate is slidably mounted on the two fastening plate, the slide plate is fastened to the adhesive dispensing assembly and is slidably engaged with the connecting plate.

6. The adhesive dispenser as claimed in claim 5, wherein the moving assembly further includes two guiding plates and two seats, the two guiding plates are arranged in parallel on the base, each seat is slidably mounted on one of the guiding plates.

7. The adhesive dispenser as claimed in claim 1, wherein moving assembly drives the adhesive dispensing assembly on a X-direction, a Y-direction, and a Z-direction to block the light beam of the first pair of light elements on the X-direction and the Z-direction and to block the light beam of the second pair of light elements on the Y-direction.

8. The adhesive dispenser as claimed in claim 7, wherein two slide blocks are formed on the connecting plate, each slide block is slidably engaged with one fastening plate.

9. A method of regulating position of an adhesive nozzle of an adhesive dispenser, the method comprising:
mounting a new adhesive nozzle and moving the new adhesive nozzle into a detecting assembly through a moving assembly;
moving the adhesive nozzle to block light beams transmitted from a first pair of light elements and a second pair of light elements;
triggering a control signal by the first pair of light elements and the second pair of light elements;
receiving the control signal and recording the coordinate position of the adhesive nozzle;
calculating a variety of the recorded coordinate position and a reference coordinate position of the adhesive nozzle;
regulating the position of the adhesive nozzle according to the variety.

10. The adhesive nozzle regulating method as claimed in claim 9, the step of mounting the adhesive nozzle further comprising:
moving the adhesive nozzle along a X-direction and a Z-direction until a extreme point that blocking the light beam transmitted from the first pair of light elements;
moving the adhesive nozzle along a Y-direction until blocking the light beam transmitted from the second pair of light elements.

11. The adhesive nozzle regulating method as claimed in claim 10, wherein the adhesive nozzle at the extreme point blocks the light beam transmitted from the first pair of light elements on both the X-direction and the Z-direction, the adhesive nozzle can not block the light beam transmitted from the first pair of light elements on the X-direction and the Z-direction when crossing the extreme point.
